(19) United States
(12) Patent Application Publication
(10) Pub. No.: US 2024/0424744 A1
(43) Pub. Date: Dec. 26, 2024

(54) HEAT-SEALING TOOL FOR SEALING PLASTIC FILMS

(71) Applicant: ROPEX Industrie-Elektronik GmbH, Bietigheim-Bissingen (DE)

(72) Inventors: Manuel SCHULLER, Bietigheim-Bissingen (DE); Frank PETERS, Bietigheim-Bissingen (DE)

(21) Appl. No.: 18/751,937

(22) Filed: Jun. 24, 2024

(30) Foreign Application Priority Data
Jun. 22, 2023 (EP) 23181012

(51) Int. Cl. B29C 65/22; B29C 65/00

(52) U.S. Cl. CPC B29C 65/224; B29C 66/72; B29C 66/8181

(57) ABSTRACT

Heat-sealing tool for sealing plastic films, having a sealing tape made of an electrically conductive material. A width of the sealing tape is 2 mm to 1000 mm, a length of the sealing tape is 2 mm to 2000 mm and a thickness of the sealing tape is 0.1 mm to 4 mm, and a largest surface of the sealing tape is provided with a plurality of recesses, in which a sum of cross-sectional areas of the recesses in a cross-sectional plane aligned parallel to the largest surface amounts to a maximum of 50 percent of an area of the largest surface.

This application claims priority to European Patent Application No. 23181012.8 filed Jun. 22, 2023, which is incorporated by reference.

The invention relates to a heat-sealing tool for the heat-sealing of plastic films.

The basic principle of such a heat-sealing tool is known from U.S. Pat. No. 4,010,063 A.

### SUMMARY OF THE INVENTION

The object of the invention is to provide a heat-sealing tool with which thin-walled plastic films can be sealed.

This task is solved for a heat-sealing tool of the type mentioned above by the fact that the heat-sealing tool comprises a sealing tape or sealing band made of an electrically conductive material, wherein a width of the sealing tape is 2 mm to 1000 mm, a length of the sealing tape is 2 mm to 2000 mm and a thickness of the sealing tape is 0.1 mm to 4 mm and wherein a largest surface of the sealing tape is provided with a plurality of recesses, wherein a sum of cross-sectional areas of the recesses, in particular being projected in a cross-sectional plane aligned parallel to the largest surface, is at most 50 percent of an area of the largest surface.

A known sealing tape is strip-shaped and has a length that is considerably greater than its width. Furthermore, the thickness of the sealing tape is many times smaller than its length. This means that the flexibility of the sealing tape in a sealing surface, in particular a sealing plane, which is determined by the largest surface of the sealing tape, can be selected in such a way that at least slight deviations in thickness in the plastic films to be sealed can be compensated for by the sealing tape and any flexible support of the sealing tape that may be provided. To simplify matters, the geometry of the sealing tape can be described in particular by a cuboid, whereby variants of sealing tapes can also have a curved course in at least one plane, in particular in a sealing plane.

A sealing tape whose width is at least 5 percent of the length of the sealing tape can also be used to weld thin-walled plastic films to one another without the sealing seam being damaged when even a small amount of tensile force is applied to the product formed from the welded plastic films, which may be a tubular bag, for example. On the contrary, the geometry of the sealing tape according to the invention forms a wide sealing seam, in which an advantageous distribution of tensile forces is also ensured for thin-walled plastic films. In order to ensure the most even heat distribution possible in such a wide sealing tape and to achieve an energy-efficient operating mode for the sealing tape, a large number of recesses are incorporated in the largest surface of the sealing tape, which determines the contact surface with the plastic film and thus the sealing surface or sealing plane. These recesses extend from a first largest surface of the sealing tape facing the plastic film through the sealing tape to a second largest surface of the sealing tape facing away from the plastic film. As a purely exemplary case, the recesses are cut out of the sealing tape during the production of the sealing tape by a suitable cutting process, in particular from the group: laser cutting, water jet cutting, punching. Alternatively, the sealing tape can be produced by a photo-chemical process, in particular by etching, or by a galvanic build-up process.

To ensure that the sealing tape functions properly, the sum of the cross-sectional areas of the recesses in a cross-sectional plane parallel to the largest surface must not exceed 50 percent, in particular must not exceed 30 percent, of the area of the largest surface. For a sealing tape in the form of a cuboid, the area of the largest surface is given by the product of the length and width. The sum of the cross-sectional areas of the recesses can be determined directly for the largest surface in the case of a cuboid sealing tape; in the case of curved largest surfaces or three-dimensionally shaped largest surfaces, a projection of the recesses into a cross-sectional plane is suitable for determining the sum of the cross-sectional areas. It is preferred that the sum of the cross-sectional areas of the recesses is at least 10 percent, and particularly preferred at least 20 percent, of the area of the largest surface of the sealing tape.

The recesses may have different geometries and thus also different cross-sectional areas. It is preferred that the recesses are profiled and aligned in the same way.

Advantageous further developments of the invention are the subject of the subclaims.

It is expedient if a cross-sectional area of a largest recess amounts to a maximum of five times a mean cross-sectional area of the recesses. It is assumed here that a mean cross-sectional area of the recesses is determined by adding the cross-sectional areas of all the recesses and dividing by the number of recesses. The cross-sectional area of the largest recess should accordingly be chosen such that it is at most five times the average cross-sectional area determined in this way. This ensures that the sealing tape is not provided with recesses that lead to large areas in the sealing seam in which no heat is applied and thus no sealing takes place.

It is advantageous if the longest axes of at least 50 percent of the recesses are aligned at an angle of 70 to 110 degrees to a longest edge of the sealing tape or to a section of the longest edge of the sealing tape that is directly adjacent to the respective recess. In principle, the recesses in the largest surface of the sealing tape can have a wide variety of geometries, for example circular, oval, square or rectangular. It is preferred that the recesses have a largest extension in a spatial direction parallel to the largest surface, with this largest extension determining an extension axis. In the case of a cubically shaped sealing tape, this extension axis is aligned at an angle of between 70 and 110 degrees to the longest edge of the large surface of the sealing tape. In the case of a sealing tape that is curved in some areas, the extension axis is aligned in the angle interval of 70 to 110 degrees to a section of the longest edge of the sealing tape that is closest to the respective recess.

In a further development of the invention, it is envisaged that the longest axes of the recesses are aligned parallel to one another and transverse to the longest edge of the sealing tape. It is assumed here that the largest surface of the sealing tape is rectangular.

In one embodiment of the invention, the recesses are arranged in a constant pitch in a longitudinal direction of the sealing tape and/or in a transverse direction of the sealing tape. Such a regular arrangement of the recesses can cause a favorable deformation behavior for the sealing tape that is uniform for all sections of the sealing tape. This applies in particular if the recesses all have the same geometry. This can be used to ensure that the distances between the recesses are identical both in the longitudinal direction of the sealing tape and in the transverse direction of the sealing tape.

It is preferred that the recesses are slit-shaped with a transverse extension that is at least twice the longitudinal extension. It is preferred that the recesses have a rectangular cross-sectional area, whereby it may additionally be provided that the corners of the cross-sectional area are rounded. The transverse extension is the extension that is aligned parallel to the width of the, preferably rectangular, sealing tape. The longitudinal extension is the extension that is aligned parallel to the longest edge and thus also parallel to the length of the, preferably rectangular, sealing tape.

Alternatively, the task of the invention for a heat-sealing tool of the type mentioned at the beginning is solved by the fact that the sealing tape is made of an electrically conductive material, which has a first contact area at a first end region for electrical contact with a first electrode and a second contact area at a second end region for electrical contact with a second electrode and that in a heating area, which is formed between the first contact area and the second contact area, it is provided with at least one recess from the group: through-hole, notch, meander cut, so that a distance between the first contact area and the second contact area is smaller than a length of an electrical path between the first contact area and the second contact area. The distance between the first contact area and the second contact area is the shortest straight line that extends between the first contact area and the second contact area. The length of this straight line is shorter than the length of the electrical path that the electrons have to take to move from the first contact area to the second contact area when a current flows through the sealing tape. The number, geometry and arrangement of the recesses in the heating area play a decisive role here, as these recesses determine the path of the electrons and thus the length of the electrical path. A through-hole in the heating area is a recess that is completely surrounded by the material of the sealing tape. A notch in the heating area is a cut in the sealing tape that extends from an edge area of the sealing tape and is not completely surrounded by the material of the sealing tape. A meander cut is formed by a linear recess which is optionally completely or not completely surrounded by the material of the sealing tape and which has at least one kink and/or at least one bend in its course, so that a first section of the recess before the kink or the bend and a second section of the recess after the bend or the bend define an angle of at least 90 degrees, preferably at least 120 degrees, particularly preferably at least 150 degrees and in particular at least 180 degrees. It is particularly advantageous if the meander cut has several bends and/or curves, with successive bends or curves being formed in opposite directions.

It is preferably provided that a first heating area section and a second heating area section adjacent thereto are provided along the distance between the first contact area and the second contact area, the first heating area section having a first electrical resistance and the second heating area section having a second electrical resistance which is equal to the first electrical resistance, preferably greater than the first electrical resistance. This means that when electric current flows through the sealing tape, the second heating area section has the same temperature compared with the first heating area section, if the second electrical resistance is equal to the first electrical resistance or preferably has a higher temperature than the first heating area section, if the second electrical resistance is higher than the first electrical resistance. This is particularly the case when the length of the first and second heating area sections along the distance between the first contact area and the second contact area are the same.

In a further development of the invention, it is envisaged that the first heating area section has a first arrangement of recesses that determine a first electrical resistance and the second heating area section has a second arrangement of recesses that determine a second electrical resistance that is equal to or greater than the first electrical resistance. To determine the resistance, the ohmic resistance of the respective heating area section is taken as a basis and related to the extent of the respective heating area section along the distance between the first contact area and the second contact area, so that an electrical resistance per unit length is described.

In a further embodiment of the invention, it is provided that the first heating area section has a first averaged cross-section in a cross-sectional plane oriented transversely to the distance between the first contact area and the second contact area, and that the second heating area section has a second averaged cross-section in the cross-sectional plane, which is equal to or smaller than the first averaged cross-section. In this case, the averaged cross-section for the respective heating area section is determined as the sum of all individual cross-sections of the respective heating area section determined along the distance between the first contact area and the second contact area, in particular at equal distances, and then related to the longitudinal extent of the heating area section. The differences between the averaged cross-sections of the respective heating area sections can be attributed to different widths of the respective heating area sections in a spatial direction transverse to the distance and/or to a different number and size of recesses in the respective heating area section.

It is expedient for the sealing strip to be made of a metallic material, in particular a stainless-steel material. This is a favorable way of meeting the requirements for the sealing strip in terms of temperature resistance and electrical conductivity, as well as mechanical resistance. This applies in particular if the sealing strip is made of a stainless-steel material.

In a further embodiment of the invention, it is envisaged that the sealing tape is assigned a dimensionally stable supporting body, in particular a cuboid supporting strip, which has a supporting surface, one of the two largest surfaces of the sealing tape resting on the supporting surface. By way of example, it is envisaged that the supporting body is produced as a supporting strip, for example from a metallic material such as aluminum or steel, and is intended to be clamped in a welding device. The purpose of the supporting body is to distribute the forces required to carry out the sealing process, which are provided by the welding device, for example by means of a corresponding actuator, as evenly as possible over the sealing tape in order to achieve a homogeneous weld for the plastic films to be joined together. As an example, the supporting bar is cuboid in shape and has a length that at least essentially corresponds to the length of the sealing tape. The width of the supporting body is chosen to be equal to or greater than the width of the sealing tape.

The height or thickness of the supporting body is typically equal to or greater than the width of the supporting body.

In addition, a rubber-elastic and/or electrically insulating intermediate layer is arranged between the supporting surface and the sealing tape. The intermediate layer, which can be made, for example, of a rubber-elastic silicone material, serves to compensate for slight unevenness that the plastic films to be welded together may have. Furthermore, the intermediate layer ensures electrical insulation between the sealing tape and the supporting strip if the material is chosen appropriately, in particular if silicone is used for the intermediate layer. It is preferred that the intermediate layer at least almost completely covers the supporting surface formed on the supporting body and serving to support the sealing tape.

In a further development of the invention, it is envisaged that the largest surface of the sealing tape, which is facing away from the supporting strip, is covered by a temperature-resistant separating film and/or that the supporting body is penetrated by at least one cooling channel, in particular aligned parallel to the supporting surface. The temperature-resistant separating film, which may be a glass-fiber-reinforced film coated with PTFE (polytetrafluoroethylene), for example, prevents the plastic film to be welded from sticking to the sealing tape. Furthermore, the temperature-resistant separating film also serves to reduce wear on the sealing tape and/or to equalize the temperature within the sealing surface determined by the sealing tape and/or to standardize the surface pressure acting on the plastic film.

### BRIEF DESCRIPTION OF THE DRAWINGS

The advantageous embodiments of the invention are shown in the drawing. Here shows:

FIG. 1: a heat-sealing device with a heat-sealing tool comprising a supporting body and a sealing tape, and a counter-tool arranged opposite the heat-sealing tool,

FIG. 2: a top view of a first embodiment of a sealing tape,

FIG. 3: a sectional view of the sealing tape according to FIG. 2,

FIG. 4: a second embodiment of a sealing tape that is essentially rectangular in shape, and

FIG. 5: a third embodiment of a sealing tape that is essentially rectangular in shape.

### DETAILED DESCRIPTION OF THE INVENTION

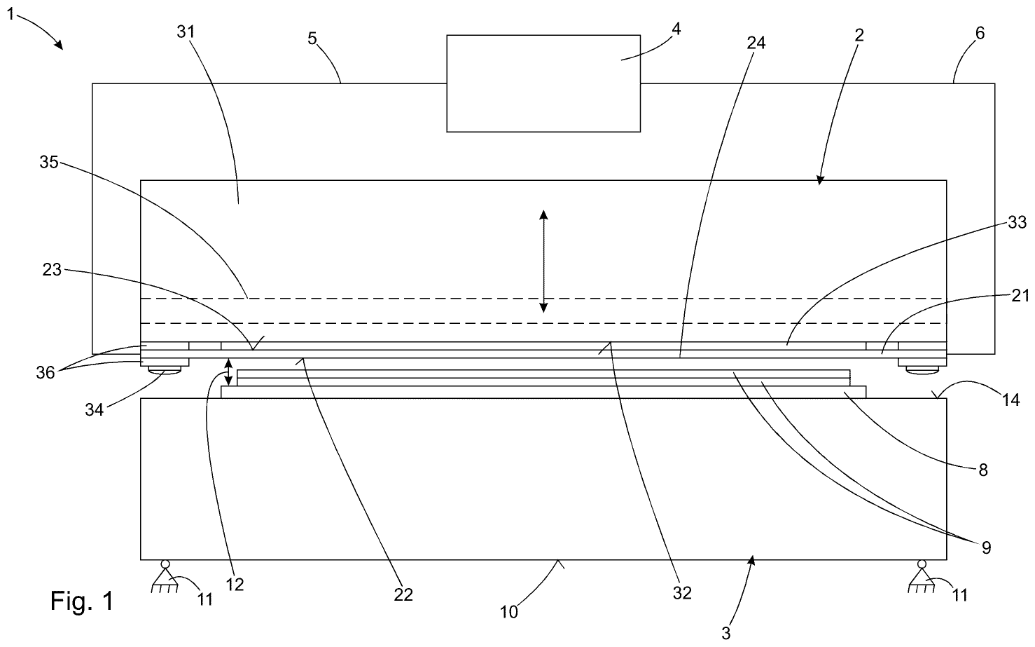

A heat-sealing device 1, shown only schematically in FIG. 1, comprises a heat-sealing tool 2 and a counter-tool 3 arranged opposite the heat-sealing tool 2. A power source 4 is assigned to the heat-sealing tool 2 and is electrically connected to a sealing tape 21 belonging to the heat-sealing tool 2 via a supply line 5 and a discharge line 6. It is envisaged, purely by way of example, that the counter-tool 3 is fixed in a stationary manner to a machine frame (not shown), which machine frame is symbolized by the bearing elements 11 arranged on an underside 10 of the counter-tool 3. Furthermore, it is envisaged that the heat-sealing tool 2 is mounted on the machine frame, which is not shown, in such a way that it can move in a linear fashion, and that the heat-sealing tool 2 is assigned an actuator, which is not shown and which is supported on the machine frame.

The actuator allows a vertical movement of the heat-sealing tool 2 with respect to the counter tool 3. When the heat-sealing tool 2 moves vertically downward, the distance between the heat-sealing tool 2 and the counter-tool 3 changes, this distance also being referred to as the working gap 12, into which two plastic films 9, aligned parallel to one another, can be inserted purely by way of example, which are to be welded together with the sealing device 1.

As an example, the heat-sealing tool 2 comprises a cuboid-shaped supporting body 31, which has a supporting surface 32 that is flat and faces the counter-tool 3. The supporting surface 32 carries an intermediate layer 33, which is produced purely as an example as a film layer of constant thickness from a rubber-elastic silicone material and covers the supporting surface 32 in some areas. Furthermore, it can be provided that the supporting body 31 is penetrated by a cooling channel 35, which is preferably aligned parallel to the supporting surface 32 and is shown with a dashed line.

A plate-shaped pressure pad 8 is arranged on an upper side 14 of the counter-tool 3, which is designed in a cuboid shape purely as an example, and can be made of a rubber-elastic silicone material in the same way as the intermediate layer 33. The plastic films 9 are placed on the pressure pad 8 to carry out the sealing process and are uniformly subjected to a compressive force by a vertical approach movement of the heat-sealing tool 2, which approach movement is caused by an actuator (not shown) acting on the heat-sealing tool.

Furthermore, an electric current is passed from the power source 4 through the sealing tape 21 via the supply line 5 and the discharge line 6, which causes the sealing tape 21 to heat up for effecting the desired sealing process for the plastic films.

The sealing tape 21 extends with its longest edge 24 in the horizontal direction, as shown in FIG. 1, and is fixed at each end to sealing tape holders 34, which in turn are attached to the supporting body 31. For example, the sealing tape holders 34 are screwed into the supporting body 31 and provided with insulating washers 36 to ensure that the sealing tape 21 is electrically insulated from the supporting body 31.

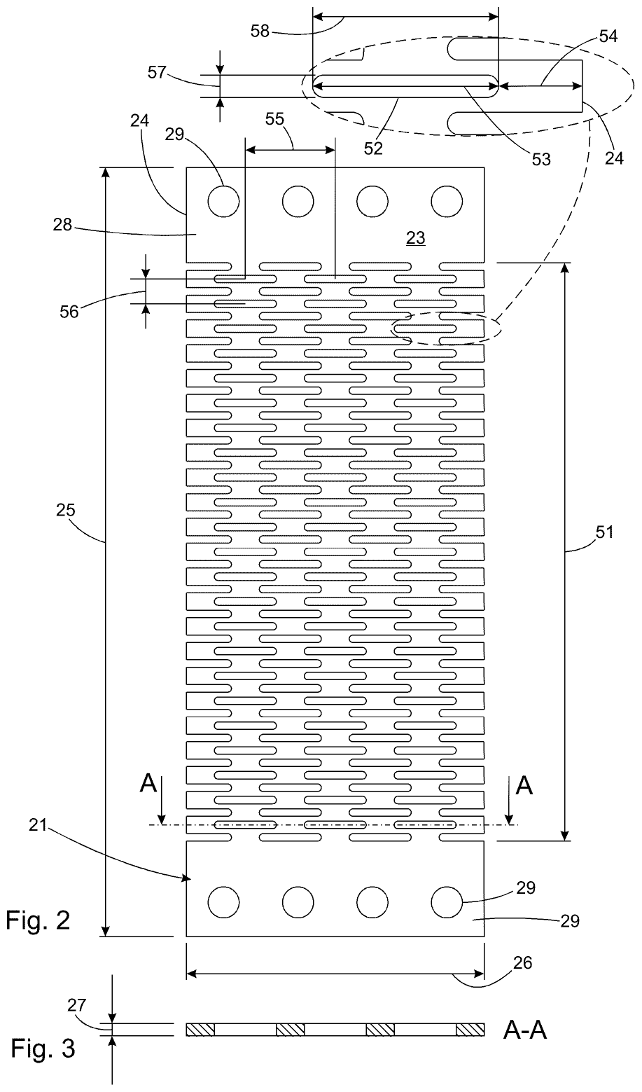

As can be seen from the illustration in FIG. 2, which shows a top view of the purely exemplary rectangular sealing tape 21 according to FIG. 1, the length 25 of the longest edge 24 is approximately 2.5 times the width 26.

At the opposite end areas 28, the sealing tape 21 is provided with four holes 29 each, which are penetrated by the sealing tape holders 34, which are designed as screws, for example, when the sealing tape 21 is mounted on the supporting body 31.

Furthermore, the largest surfaces 22, 23 of the sealing tape 21, which are aligned opposite one another, are penetrated in a central section 51 by a multiplicity of recesses 52. As an example, the recesses 52 are arranged in the direction of the width 26 of the sealing tape 21 at the same pitch 55. Furthermore, the recesses 52 are arranged in the same lengthwise division or pitch 56 in the direction of the length 25 of the sealing tape 21. In addition, it is provided that the recesses 52 are arranged in lines with respect to the representation of FIG. 2 and are arranged in lines adjacent to one another, offset by half their pitch 55.

The slot-shaped recesses 52 each have an axis of extension 53, as shown in the detailed representation of FIG. 2, which is aligned at a right angle to the longest edge 24 of the sealing tape 21, purely by way of example. In this case, the condition is also met that the extension axis 53 is aligned transversely to a section of the longest edge 24, which is arranged at a minimum distance 54 from the respective recesses 52. As an example, some of the recesses 52 are arranged in such a way that they break through the longest edge 24 of the sealing tape 21 in the manner of notches. This arrangement of the recesses 52 is not absolutely necessary to ensure the function of the sealing tape 21, but it does increase the elasticity of the sealing tape 21 in the direction of the longest edge 24. For example, an extension of a transverse extension 58 of the recess 52 is a multiple of an extension of a longitudinal extension 57 of the recess 52.

As can be seen from the illustration in FIG. 3, the thickness 27 of the sealing tape 21 is considerably smaller than the length 25 and the width 26 and, purely by way of example, is approximately 1.5 percent of the length 25 of the sealing tape 21.

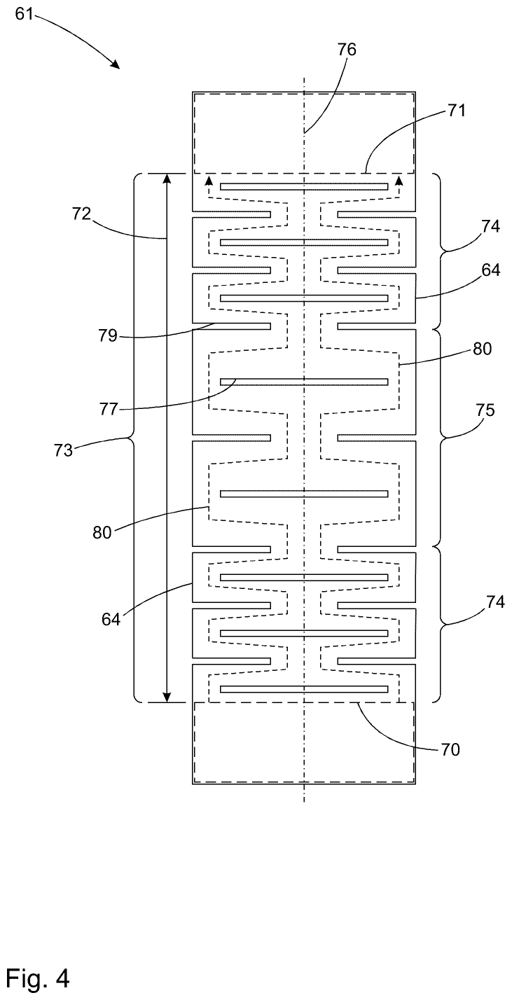

The sealing tape 61 shown in FIG. 4 is essentially rectangular in shape and is made purely as an example of a metal band from a stainless-steel material. As can be seen from the purely schematic representation in FIG. 4, the sealing tape 61 has a first contact area 70 and a second contact area 71 at opposite ends, which are each intended for connection to electrodes of a heat-sealing tool, which are also not shown in more detail. A heating area 73 extends between the two contact areas 70, 71, which are arranged at a distance 72 from each other. As an example, the heating area 73 has two differently designed heating area sections 74, 75. As can be seen from the representation in FIG. 4, the first heating area section 74 adjoins the first contact area 70 and extends as far as the second heating area section 75. This extends as far as a further heating area section, which is designed in the same way as the first heating area section 74 and is therefore also referred to as a further first heating area section 74.

By way of example, it is envisaged that the first heating area section 74 has a total of three transverse slots 77, each arranged symmetrically to a center axis 76 aligned parallel to the distance 72, which extend from the center axis 76 in the direction of the respective longest edge 64, but each maintain a distance from the respective longest edge 64. The transverse slots 77 are arranged along the center axis 76, all of them with the same pitch, purely by way of example. Furthermore, it is provided that notches 79 are formed on each transverse slot 77, symmetrically aligned with the center axis and extending from the longest edge 64, but not extending to the center axis 76. The transverse slots 77 and the notches 79 ensure that electrons, which are provided at the first contact area 70 and are to reach the second contact area 71, have to take a large number of detours, so that an electrical resistance for the first heating area section 74 is considerably greater than an electrical resistance of a strip-shaped sealing tape that has the same length as the first heating area section.

The second heating section 75 is connected to the first heating section 74 along the center axis 76 and has a smaller number of transverse slots 77 and notches 79 than the first heating section 74 and therefore has a lower electrical resistance than the first heating section 74. Assuming that the first heating area section 74 and the second heating area section 75 have the same length in the direction of the center axis 76, the ohmic resistance of the first heating area section 74 is thus greater than the ohmic resistance of the second heating area section 75.

The second heating area section 75 is followed by another heating area section that is designed in the same way as the first heating area section 74.

Two current paths 80 are shown in FIG. 4 to illustrate that the length of the two current paths 80 is significantly greater than the distance 72. The different number and arrangement of transverse slots 77 and notches 79 thus ensures that the current density in the sealing tape 61 is at a maximum in the area of the first heating area sections 74, which means that more heat is generated there than in the second heating area section 75, which has a lower current density due to the smaller number of transverse slots 77 and notches 79.

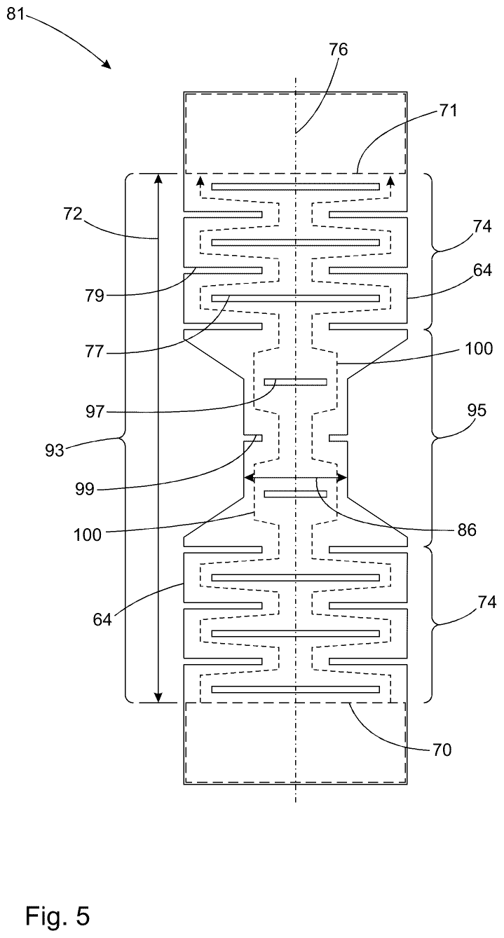

The third embodiment of a sealing tape 81 shown in FIG. 5 differs from the second embodiment of the sealing tape 61 in the design of the second heating area section 95 of the heating area 93, while the other areas of the sealing tape 81 are designed in the same way as the sealing tape 61, so that the same reference signs are used for this and a new description is dispensed with.

The second heating area section 95 has a smaller width 86 compared with the first heating area section 74, which means that the sealing tape 81 can be used to realize a customer-specified sealing seam geometry, for example. Despite the smaller width 86 of the second heating area section 95, it is necessary to provide the second heating area section 95 with transverse slots 97 and notches 99 in order to achieve an alignment of the cross-section effectively available the cross-section effectively available for the current flow in the second heating area section 95 to the cross-sections effectively available for the current flow in the first heating area sections 74 bordering on both sides of the second heating area section 95.

The embodiment shown in FIG. 5 thus has the aim of ensuring a substantially homogeneous temperature distribution when the sealing tape 81 is in operation, despite the greatly varying geometries of the heating area sections 74, 95.

1. A heat-sealing tool for sealing plastic films, having a sealing tape made of an electrically conductive material, wherein a width of the sealing tape is 2 mm to 1000 mm, a length of the sealing tape is 2 mm to 2000 mm and a thickness of the sealing tape is 0.1 mm to 4 mm, and wherein a largest surface of the sealing tape is provided with a plurality of recesses, wherein a sum of cross-sectional areas of the recesses amounts to a maximum of 50 percent of an area of the largest surface.

2. The heat-sealing tool according to claim 1, wherein a cross-sectional area of a largest recess is at most five times a mean cross-sectional area of the recesses.

3. The heat-sealing tool according to claim 1, wherein longest axes of extension of at least 50 percent of the recesses are aligned at an angle of 70 to 110 degrees to a longest edge of the sealing tape or to a section of the longest edge of the sealing tape that is directly adjacent to the respective recess.

4. The heat-sealing tool according to claim 1, wherein longest axes of extension of the recesses are aligned parallel to one another and transversely to a longest edge of the sealing tape.

5. The heat-sealing tool according to claim 1, wherein the recesses are arranged in a constant pitch in a longitudinal direction of the sealing tape and/or in a transverse direction of the sealing tape.

6. The heat-sealing tool according to claim 1, wherein the recesses are shaped in the form of slots with a transverse extent which is at least twice a longitudinal extent of the recesses.

7. A heat-sealing tool for sealing plastic films, having a sealing tape made of an electrically conductive material, which has a first contact region at a first end region for making electrical contact with a first electrode and a second contact region for making electrical contact with a second electrode, and which is provided in a heating region, which is formed between the first contact region and the second contact region, with at least one recess from the group: through-hole, notch, meander cut, so that a distance between the first contact area and the second contact area is smaller than a length of an electrical path between the first contact area and the second contact area.

8. The heat-sealing tool according to claim 7, wherein a first heating area section and a second heating area section adjoining the first heating area section are provided along the distance between the first contact area and the second contact area, the first heating area section having a first electrical resistance and the second heating area section having a second electrical resistance which is equal to or greater than the first electrical resistance.

9. The heat-sealing tool according to claim 8, wherein the first heating area section has a first arrangement of recesses which determine a first electrical resistance, and the second heating section has a second arrangement of recesses which determine a second electrical resistance which is equal to or greater than the first electrical resistance.

10. The heat-sealing tool according to claim 7, wherein the first heating region section has a first averaged cross-section in a cross-sectional plane oriented transversely to the distance between the first contact region and the second contact region cross-sectional plane, and that the second heating area section has a second averaged cross-section in the cross-sectional plane, which is equal to or smaller than the first averaged cross-section.

11. The heat-sealing tool according to claim 1, wherein the sealing tape is made of a metallic material.

12. The heat-sealing tool according to claim 1, wherein the sealing tape is assigned a dimensionally stable supporting body which has a supporting surface wherein one of the two largest surfaces of the sealing tape rests on the supporting surface.

13. The heat-sealing tool according to claim 12, wherein a rubber-elastic and/or electrically insulating intermediate layer is arranged between the supporting surface and the sealing tape.

14. The heat-sealing tool according to claim 12, wherein the largest surface of the sealing tape facing away from the supporting body is covered by a temperature-resistant separating film and/or wherein the supporting body is penetrated by at least one cooling channel.

15. The heat-sealing tool according to claim 7, wherein the sealing tape is made of a metallic material.

16. The heat-sealing tool according to claim 7, wherein the sealing tape is assigned a dimensionally stable supporting body which has a supporting surface wherein one of the two largest surfaces of the sealing tape rests on the supporting surface.

17. The heat-sealing tool according to claim 16, wherein a rubber-elastic and/or electrically insulating intermediate layer is arranged between the supporting surface and the sealing tape.

18. The heat-sealing tool according to claim 16, wherein the largest surface of the sealing tape facing away from the supporting body is covered by a temperature-resistant separating film and/or wherein the supporting body is penetrated by at least one cooling channel.
